(19) United States
(12) Patent Application Publication
(10) Pub. No.: US 2005/0276512 A1
(43) Pub. Date: Dec. 15, 2005

(54) Selective deconvolution of an image

(75) Inventors: Matthew R. C. Atkinson, Cottage Grove, MN (US); Kurt J. Halverson, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/858,130

(22) Filed: Jun. 1, 2004

(51) Int. Cl. G06K 9/00

(52) U.S. Cl. 382/279

(57) ABSTRACT

A method and system are provided for the selective use of deconvolution to reduce crosstalk between features of an image. The method to select areas of an image for deconvolution comprising the steps of: a) providing an image comprising a plurality of features, wherein each feature is associated with at least one value (v); b) identifying a test feature which is a high-value feature adjacent to a known low-value zone of the image, wherein the test feature has a tail ratio (rₜ), which is the ratio of the value of the test feature (vₜ) to the value of the adjacent low-value zone of the image (vₒ); c) calculating a threshold value t which is a function of tail ratio (rₜ) of the test feature; and d) identifying selected areas of the image, the selected areas being those where the ratio of values (v) between adjacent features is greater than said threshold value (T(rₜ)). Typically, the method of the present invention additionally comprises the step of deconvolving the selected areas of the image.

### FIELD OF THE INVENTION

This invention relates to image processing, and, in particular, the selective use of deconvolution to reduce crosstalk between features of an image. By selecting relevant areas for deconvolution, a process which typically involves intensive calculations, the present invention can greatly reduce the calculation effort needed to provide superior image quality.

### BACKGROUND OF THE INVENTION

U.S. Pat. No. 6,477,273, incorporated herein by reference, discloses methods of centroid integration of an image. U.S. Pat. No. 6,633,669, incorporated herein by reference, discloses methods of autogrid analysis of an image. U.S. patent application Ser. No. 09/917,545, incorporated herein by reference, discloses methods of autothresholding of an image.

### SUMMARY OF THE INVENTION

Briefly, the present invention provides a method to select areas of an image for deconvolution comprising the steps of: a) providing an image comprising a plurality of features, wherein each feature is associated with at least one value (v); b) identifying a test feature which is a high-value feature adjacent to a known low-value zone of the image, wherein the test feature has a tail ratio (rₜ), which is the ratio of the value of the test feature (vₜ) to the value of the adjacent low-value zone of the image (vₒ); c) calculating a threshold value t which is a function of tail ratio (rₜ) of the test feature; and d) identifying selected areas of the image, the selected areas being those where the ratio of values (v) between adjacent features is greater than said threshold value (T(rₜ)). The image typically comprises features arranged in a grid. Typically, a pseudo-image is formed by autogrid analysis. Typically, step b) additionally comprises subtracting a background constant from both the value of the test feature (vₜ) and the value of the adjacent low-value zone of the image (vₒ) before calculating the tail ratio (rₜ). The background constant may optionally be taken to be the value of a (v_{b}) of a low-value zone of the image which is sufficiently distant from any feature as to avoid any tail effect, which may optionally be a low-value zone of the image which is at least twice as distant from any feature as the average distance between features. Typically, threshold value (T(rₜ)) is a multiple of tail ratio (rₜ) of said test feature. Typically, the method of the present invention additionally comprises the step of deconvolving the selected areas of the image.

In another aspect, the present invention provides a system for selecting areas of an image for deconvolution, the system comprising: a) an image device for providing a digitized image; b) a data storage device; and c) a central processing unit for receiving the digitized image from the image device and which can write to and read from the data storage device, the central processing unit being programmed to:
i) receive a digitized image from the image device;
ii) identify a plurality of features and associate each feature with at least one value (v);
iii) identify a test feature which is a high-value feature adjacent to a known low-value zone of the image, wherein the test feature has a tail ratio (rₜ) which is the ratio of the value of the test feature (vₜ) to the value of the adjacent low-value zone of the image (vₒ);
iv) calculate a threshold value t which is a function of tail ratio (rₜ) of the test feature; and
v) identify selected areas of said image, said selected areas including less than the entire image, the selected areas being those where the ratio of values (v) between adjacent features is greater than said threshold value (T(rₜ)).
   The image typically comprises features arranged in a grid. Typically, the central processing unit is additionally programmed to form a pseudo-image by autogrid analysis. Typically, step iii) additionally comprises subtracting a background constant from both the value of the test feature (vₜ) and the value of the adjacent low-value zone of the image (vₒ) before calculating the tail ratio (rₜ). The background constant may optionally be taken to be the value of a (v_{b}) of a low-value zone of the image which is sufficiently distant from any feature as to avoid any tail effect, which may optionally be a low-value zone of the image which is at least twice as distant from any feature as the average distance between features. Typically, threshold value (T(rₜ)) is a multiple of tail ratio (rₜ) of said test feature. Typically, the central processing unit is additionally programmed to deconvolve the selected areas of the image.

It is an advantage of the present invention to provide a method to reduce the calculation effort necessary to derive high quality data from an image.

### BRIEF DESCRIPTION OF THE DRAWING

FIG. 1 is a schematic illustration of a prototypical scanning system with which the present invention might be used.

FIG. 2 is a subject image used in the Example below.

FIG. 3 is an analysis grid of the image of FIG. 2, as described in the Example below.

FIG. 4 is a detail of FIG. 2 including the feature at the first column, fifth row, of FIG. 2.

FIG. 5 is a graph of pixel intensity integrated over 4 pixels in the y direction plotted against x position for a segment of FIG. 4.

### DETAILED DESCRIPTION

The present invention provides a method to select areas of an image for deconvolution. Any suitable method of deconvolution known in the art may be used, including iterative and blind methods. Iterative methods include Richardson-Lucy and Iterative Constrained Tikhovan-Miller methods. Blind methods include Weiner Filtering, Simulated Annealing and Maximum Likelihood Estimators methods. Deconvolution may reduce cross-talk between features in an image, such as the false lightening of a relatively dark feature due to its proximity to a light feature.

The method of selection comprises the steps of: a) providing an image comprising a plurality of features, wherein each feature is associated with at least one value (v); b) identifying a test feature which is a high-value feature adjacent to a known low-value zone of the image, wherein the test feature has a tail ratio (rₜ), which is the ratio of the value of the test feature (vₜ) to the value of the adjacent low-value zone of the image (vₒ); c) calculating a threshold value t which is a function of tail ratio (rₜ) of the test feature; and d) identifying selected areas of the image, the selected areas being those where the ratio of values (v) between adjacent features is greater than said threshold value (T(rₜ)). Typically, one or more steps are automated. More typically, all steps are automated.

The step of providing an image may be accomplished by any suitable method. Typically, this step is automated. The image may be collected by use of a video camera, digital camera, photochemical camera, microscope, telescope, visual scanning system, probe scanning system, or other sensing apparatus which produces data points in a two-dimensional array. Typically, the target image is expected to be an image containing distinct features, which, however, may additionally contain noise. Typically the features are arranged in a grid comprising rows and columns. As used herein, “column” will be used to indicate general alignment of the features in one direction, and “row” to indicate general alignment of the features in a direction generally orthogonal to the columns. It will be understood that which direction is the column and which the row is entirely arbitrary, so no significance should be attached to the use of one term over the other, and that the rows and columns may not be entirely straight. Alternately, a grid may comprise some other repeating geometrical arrangement of features, such as a triangular or hexagonal arrangement. Alternately, the features may be arranged in no predetermined pattern, such as in an astronomical image. If the image is not initially created in digital form by the image capturing or creating equipment, the image is typically digitized into pixels. Typically, the methods described herein are accomplished with use of a central processing unit or computer.

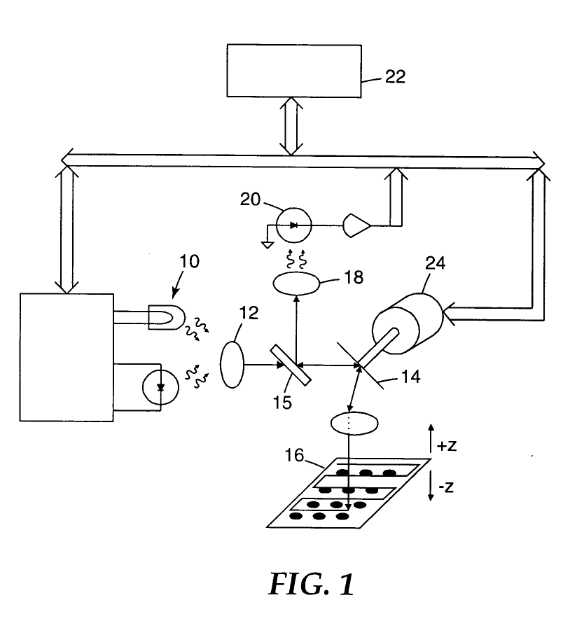

FIG. 1 illustrates a scanning system with which the present invention might be used. In the system of FIG. 1, a focused beam of light moves across an object and the system detects the resultant reflected or fluorescent light. To do this, light from a light source 10 is focused through source optics 12 and deflected by mirror 14 onto the object, shown here as a sample 3×4 assay plate 16. The light from the light source 10 can be directed to different locations on the sample by changing the position of the mirror 14 using motor 24. Light that fluoresces or is reflected from sample 16 returns to detection optics 18 via mirror 15, which typically is a half silvered mirror. Alternatively, the light source can be applied centrally, and the emitted or fluoresced light can be detected from the (side of the system, as shown in U.S. Pat. No. 5,900,949, or the light source can be applied from the side of the system and the emitted or fluoresced light can be detected centrally, or any other similar variation. Light passing through detection optics 18 is detected using any suitable image capture system 20, such as a television camera, CCD, laser reflective system, photomultiplier tube, avalanche photodiode, photodiodes or single photon counting modules, the output from which is provided to a computer 22 programmed for analysis and to control the overall system. Computer 22 typically will include a central processing unit for executing programs and systems such as RAM, hard drives or the like for data storage. It will be understood that this description is for exemplary purposes only; the present invention can be used equally well with “simulated” images generated from magnetic or tactile sensors, not just with light-based images, and with any object to be examined, not just sample 16.

The image may be subjected to centroid integration and autogrid analysis, as described in U.S. Pat. Nos. 6,477,273 and 6,633,669, incorporated herein by reference, prior to further analysis. Each feature may be assigned an integrated intensity as provided therein as its “value,” or may be assigned a value by any other suitable method, which might include selection of local maxima as feature values, or the like. A pseudo-image, formed by autogrid analysis, may be generated.

As used herein, “high-value” and “low-value” are used in reference to bright and dark features in a photographic image. It will be understood that the terms “high-value”, “low-value” and “value” may be applied to any characteristic which might be represented in an image, including without limitation color values, x-ray transmission values, radio wave emission values, and the like, depending on the nature of the image and the apparatus used to collect the image. Typically, “high-value” would refer to a characteristic that would tend to create cross-talk in adjacent “low-value” features, depending on the nature of the image collection apparatus.

The step of identifying a test feature may be accomplished by any suitable method. Typically, this step is automated. The test feature is a high-value feature adjacent to a known low-value zone of the image. The low-value zone may be a low-value feature or an area known to be low-value, such as an edge area or other area known to be outside the area where features are expected. In one embodiment, features making up the edge of an expected grid of features are examined and a bright edge feature selected as the test feature. The feature selected as the test feature may be the highest-value of a set of candidates or may be the first examined which surpasses a pre-selected threshold. In another embodiment, the object to be imaged is provided with adjacent high-value and low-value features to serve as reference points.

A tail ratio (rₜ) is calculated by dividing the value of the test feature (vₜ) by the value of the adjacent low-value zone of the image (vₒ). Typically, a background constant is subtracted from both the value of the test feature (vₜ) and the value of the adjacent low-value zone of the image (vₒ) before calculating the tail ratio (rₜ). The background constant may be determined by any suitable method. The background constant may be taken to be the value of a (v_{b}) of a low-value zone of the image which is sufficiently distant from any feature as to avoid any tail effect. Where the features are arranged in a grid, the distant low-value zone is typically at least twice as distant from any feature as the average distance between features. Alternately, the background constant may be a fixed value, determined a priori to be suitable for a given apparatus.

A threshold value t is calculated, which is a function of the tail ratio (rₜ) of the test feature. Any suitable function may be used, including functions that are arithmetic, logarithmic, exponential, trigonometric, and the like. Typically the threshold value (T(rₜ)) is simply a multiple of tail ratio (rₜ), i.e., T(rₜ)=A×rₜ, where A is any suitable number but most typically between 2 and 20.

Threshold value t is then used to identify selected areas of the image by any suitable method. Typically, this step is automated. Most typically, the selected areas are those where the ratio of values (v) between adjacent features is greater than said threshold value (T(rₜ)).

This invention is useful in the automated reading of optical information, particularly in the automated reading of a matrix of sample points on a tray, slide, or suchlike, which may be comprised in automated analytical processes like DNA detection or typing. Alternately, this invention may be useful in astronomy, medical imaging, real-time image analysis, and the like. In particular, this invention is useful in reducing spatial cross-talk by deconvolution of the image without undue calculation.

Objects and advantages of this invention are further illustrated by the following example, but the particular order and details of method steps recited in these examples, as well as other conditions and details, should not be construed to unduly limit this invention.

### EXAMPLE

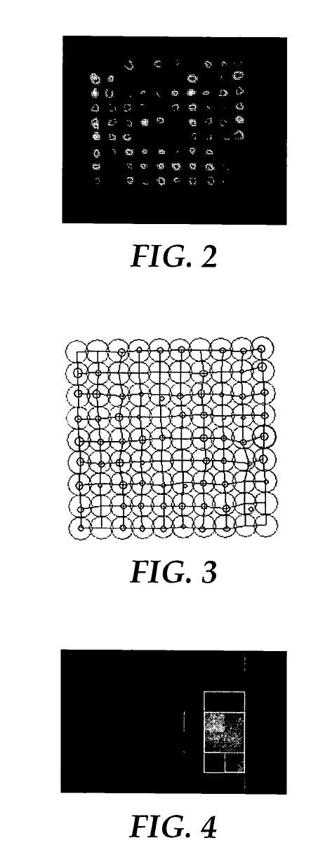

The subject image used in this example is shown in FIG. 2. The image is 74×62 pixels in size and depicts features arranged in ten columns and nine rows. The brightness of each pixel is represented by an intensity value.

The image was first subjected to autogrid analysis, as described in U.S. Pat. Nos. 6,477,273 and 6,633,669, incorporated herein by reference, including the “flexing” described in U.S. Pat. No. 6,633,669, to create the analysis grid depicted in FIG. 3 and to assign each feature an integrated intensity. Table I reports the integrated intensity value for each column and row position.

TABLE I

| | 1 | 2 | 3 | 4 | 5 | 6 | 7 | 8 | 9 | 10 |
|---|---|---|---|---|---|---|---|---|---|---|
| A | 97.8 | 105.8 | 1944.0 | 1303.0 | 1471.5 | 1922.0 | 923.0 | 1270.0 | 872.5 | 1511.0 |
| B | 2586.3 | 1462.3 | 1166.0 | 1134.8 | 1141.8 | 759.8 | 1938.8 | 858.5 | 1102.3 | 2065.0 |
| C | 2356.3 | 2160.3 | 1587.0 | 1198.5 | 1041.0 | 1336.3 | 1679.0 | 1162.0 | 1485.3 | 1612.0 |
| D | 2036.0 | 1512.0 | 1715.0 | 1312.5 | 813.5 | 1402.0 | 1742.3 | 912.8 | 854.0 | 1719.0 |
| E | 2196.0 | 1503.5 | 1367.3 | 1630.0 | 1441.3 | 99.0 | 1772.8 | 1438.5 | 1435.0 | 1511.0 |
| F | 1854.5 | 1506.0 | 1820.5 | 1272.0 | 826.5 | 966.0 | 1695.8 | 1195.5 | 1416.5 | 1832.0 |
| G | 1672.3 | 1086.0 | 1671.0 | 1165.0 | 1151.0 | 928.5 | 1488.0 | 1353.0 | 952.0 | 1632.3 |
| H | 2085.5 | 1109.8 | 1153.0 | 1455.5 | 1655.0 | 1965.0 | 1749.8 | 1743.8 | 1502.0 | 429.5 |
| I | 1457.0 | 111.5 | 1558.0 | 1428.0 | 1723.3 | 1223.0 | 1693.0 | 1139.0 | 707.0 | 112.3 |

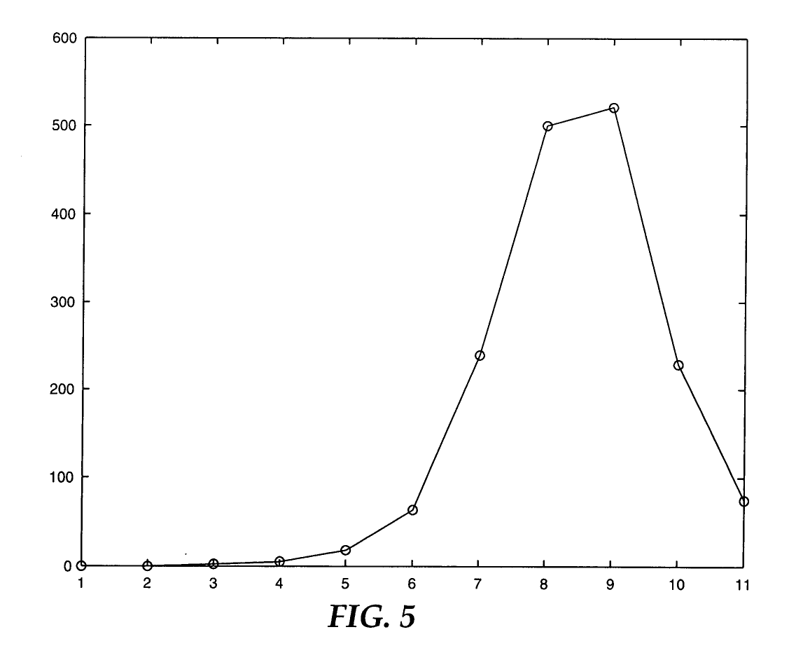

A bright edge feature at column 1, row E, was chosen as the test feature. FIG. 4 is an expanded view of this feature and the adjacent dark zone after subtraction of a background constant from each pixel. The background constant was taken to be the average intensity value of a small group of pixels at the edge of the image, at a near-maximal distance from any bright feature. FIG. 5 is a graph depicting the tail of the test feature in the x direction. For each x position, the graph reports an intensity value integrated over four pixels in the y direction. The tail ratio for this test feature is the ratio between the integrated intensity over an area in the adjacent dark zone centered one feature-width (5 pixels) away from the test feature (25, integrated over pixels 2-5 of FIG. 5) and the integrated intensity over the test feature (1489, integrated over pixels 7-10 of FIG. 5) or 0.0168.

The threshold value was taken to be 10 times the tail ratio, or 0.168. The goal is thus to select features having an intensity (b) less than 10 times as bright as the expected contribution from an adjacent bright feature; that is, less than 10 times the brightness of the adjacent feature (a) times the tail ratio. This condition can be expressed in Formula I: b<a×10×(tail ratio), or b<a×(threshold).

The integrated intensity values and the threshold were converted to logs in order to simplify successive operations. Table II contains the natural log of the integrated intensity values reported in Table I for each column and row position. The value of ln(threshold) was −1.78. Formula I is expressed in terms of logarithms in Formula II: ln(b)<ln(a)+ln(threshold), which rearranges to −ln(threshold)<ln(a)−ln(b). Taking the absolute value of the brightness difference so as to detect both bright/dark and dark/bright transitions, Formula II becomes Formula III: −ln(threshold)<|ln(a)−ln(b)|.

TABLE II

| | 1 | 2 | 3 | 4 | 5 | 6 | 7 | 8 | 9 | 10 |
|---|---|---|---|---|---|---|---|---|---|---|
| A | 4.5829 | 4.6616 | 7.5725 | 7.1724 | 7.2940 | 7.5611 | 6.8276 | 7.1468 | 6.7714 | 7.3205 |
| B | 7.8580 | 7.2878 | 7.0613 | 7.0342 | 7.0404 | 6.6331 | 7.5698 | 6.7552 | 7.0052 | 7.6329 |
| C | 7.7648 | 7.6780 | 7.3696 | 7.0888 | 6.9479 | 7.1977 | 7.4260 | 7.0579 | 7.3034 | 7.3852 |
| D | 7.6187 | 7.3212 | 7.4472 | 7.1797 | 6.7013 | 7.2457 | 7.4630 | 6.8165 | 6.7499 | 7.4495 |
| E | 7.6944 | 7.3156 | 7.2206 | 7.3963 | 7.2733 | 4.5951 | 7.4803 | 7.2714 | 7.2689 | 7.3205 |
| F | 7.5254 | 7.3172 | 7.5069 | 7.1483 | 6.7172 | 6.8732 | 7.4359 | 7.0863 | 7.2559 | 7.5132 |
| G | 7.4220 | 6.9903 | 7.4212 | 7.0605 | 7.0484 | 6.8336 | 7.3052 | 7.2101 | 6.8586 | 7.3977 |
| H | 7.6428 | 7.0119 | 7.0501 | 7.2831 | 7.4116 | 7.5832 | 7.4673 | 7.4638 | 7.3146 | 6.0626 |
| I | 7.2841 | 4.7140 | 7.3512 | 7.2640 | 7.4520 | 7.1091 | 7.4343 | 7.0379 | 6.5610 | 4.7212 |

Table III reports the absolute value of the differences between adjacent values in Table II in the x direction, i.e., |ln(a)−ln(b)|. Table III therefore contains nine columns and nine rows. The values in Table III were normalized to 1.000 by dividing by the maximum value in the table, 2.911. The normalized values are reported in Table IV. The −ln(threshold) value of 1.78 was normalized to 1.78/2.911=0.61. The normalized threshold was applied to Table IV to produce Table V, which reports a 0 for values less than −ln(threshold) or 0.61 and a 1 for values greater than −ln(threshold) or 0.61.

TABLE III

| | 1 | 2 | 3 | 4 | 5 | 6 | 7 | 8 | 9 |
|---|---|---|---|---|---|---|---|---|---|
| A | 0.0786 | 2.9110 | 0.4001 | 0.1216 | 0.2671 | 0.7335 | 0.3191 | 0.3754 | 0.5492 |
| B | 0.5702 | 0.2264 | 0.0271 | 0.0061 | 0.4073 | 0.9368 | 0.8146 | 0.2500 | 0.6277 |
| C | 0.0868 | 0.3084 | 0.2808 | 0.1409 | 0.2497 | 0.2283 | 0.3681 | 0.2455 | 0.0819 |
| D | 0.2976 | 0.1260 | 0.2675 | 0.4783 | 0.5443 | 0.2173 | 0.6464 | 0.0666 | 0.6996 |
| E | 0.3788 | 0.0950 | 0.1757 | 0.1230 | 2.6782 | 2.8852 | 0.2090 | 0.0024 | 0.0516 |
| F | 0.2082 | 0.1897 | 0.3585 | 0.4311 | 0.1560 | 0.5627 | 0.3496 | 0.1696 | 0.2572 |
| G | 0.4317 | 0.4309 | 0.3607 | 0.0121 | 0.2148 | 0.4716 | 0.0951 | 0.3515 | 0.5392 |
| H | 0.6308 | 0.0382 | 0.2330 | 0.1285 | 0.1717 | 0.1160 | 0.0034 | 0.1493 | 1.2519 |
| I | 2.5701 | 2.6371 | 0.0871 | 0.1880 | 0.3429 | 0.3252 | 0.3964 | 0.4769 | 1.8399 |

TABLE IV

| | 1 | 2 | 3 | 4 | 5 | 6 | 7 | 8 | 9 |
|---|---|---|---|---|---|---|---|---|---|
| A | 0.0270 | 1.0000 | 0.1374 | 0.0418 | 0.0918 | 0.2520 | 0.1096 | 0.1290 | 0.1887 |
| B | 0.1959 | 0.0778 | 0.0093 | 0.0021 | 0.1399 | 0.3218 | 0.2799 | 0.0859 | 0.2156 |
| C | 0.0298 | 0.1059 | 0.0965 | 0.0484 | 0.0858 | 0.0784 | 0.1264 | 0.0843 | 0.0281 |
| D | 0.1022 | 0.0433 | 0.0919 | 0.1643 | 0.1870 | 0.0747 | 0.2221 | 0.0229 | 0.2403 |
| E | 0.1301 | 0.0326 | 0.0604 | 0.0423 | 0.9200 | 0.9912 | 0.0718 | 0.0008 | 0.0177 |
| F | 0.0715 | 0.0652 | 0.1232 | 0.1481 | 0.0536 | 0.1933 | 0.1201 | 0.0583 | 0.0884 |
| G | 0.1483 | 0.1480 | 0.1239 | 0.0042 | 0.0738 | 0.1620 | 0.0327 | 0.1208 | 0.1852 |
| H | 0.2167 | 0.0131 | 0.0800 | 0.0441 | 0.0590 | 0.0398 | 0.0012 | 0.0513 | 0.4301 |
| I | 0.8829 | 0.9059 | 0.0299 | 0.0646 | 0.1178 | 0.1117 | 0.1362 | 0.1638 | 0.6320 |

TABLE V

| | 1 | 2 | 3 | 4 | 5 | 6 | 7 | 8 | 9 |
|---|---|---|---|---|---|---|---|---|---|
| A | 0 | 1 | 0 | 0 | 0 | 0 | 0 | 0 | 0 |
| B | 0 | 0 | 0 | 0 | 0 | 0 | 0 | 0 | 0 |
| C | 0 | 0 | 0 | 0 | 0 | 0 | 0 | 0 | 0 |
| D | 0 | 0 | 0 | 0 | 0 | 0 | 0 | 0 | 0 |
| E | 0 | 0 | 0 | 0 | 1 | 1 | 0 | 0 | 0 |
| F | 0 | 0 | 0 | 0 | 0 | 0 | 0 | 0 | 0 |
| G | 0 | 0 | 0 | 0 | 0 | 0 | 0 | 0 | 0 |
| H | 0 | 0 | 0 | 0 | 0 | 0 | 0 | 0 | 0 |
| I | 1 | 1 | 0 | 0 | 0 | 0 | 0 | 0 | 1 |

Table VI reports the absolute value of the differences between adjacent values in Table II in the y direction, i.e., |ln(a)−ln(b)|. Table VI therefore contains ten columns and eight rows. The values in Table VI were normalized to 1.000 by dividing by the maximum value in the table, 3.2751. The normalized values are reported in Table VII. The −ln(threshold) value of 1.78 was normalized to 1.78/3.2751=0.54. The normalized threshold was applied to Table VII to produce Table VII, which reports a 0 for values less than −ln(threshold) or 0.54 and a 1 for values greater than −ln(threshold) or 0.54.

TABLE VI

| | 1 | 2 | 3 | 4 | 5 | 6 | 7 | 8 | 9 | 10 |
|---|---|---|---|---|---|---|---|---|---|---|
| A | 3.2751 | 2.6262 | 0.5112 | 0.1382 | 0.2537 | 0.9281 | 0.7422 | 0.3916 | 0.2338 | 0.3124 |
| B | 0.0931 | 0.3902 | 0.3083 | 0.0546 | 0.0924 | 0.5646 | 0.1439 | 0.3027 | 0.2982 | 0.2477 |
| C | 0.1461 | 0.3568 | 0.0776 | 0.0909 | 0.2466 | 0.0480 | 0.0370 | 0.2414 | 0.5534 | 0.0643 |
| D | 0.0757 | 0.0056 | 0.2266 | 0.2166 | 0.5720 | 2.6505 | 0.0174 | 0.4548 | 0.5190 | 0.1290 |
| E | 0.1690 | 0.0017 | 0.2863 | 0.2480 | 0.5561 | 2.2780 | 0.0444 | 0.1850 | 0.0130 | 0.1926 |
| F | 0.1034 | 0.3270 | 0.0857 | 0.0879 | 0.3312 | 0.0396 | 0.1307 | 0.1238 | 0.3974 | 0.1154 |
| G | 0.2208 | 0.0217 | 0.3711 | 0.2226 | 0.3632 | 0.7497 | 0.1621 | 0.2537 | 0.4560 | 1.3351 |
| H | 0.3586 | 2.2979 | 0.3010 | 0.0191 | 0.0404 | 0.4742 | 0.0330 | 0.4259 | 0.7535 | 1.3414 |

TABLE VII

| | 1 | 2 | 3 | 4 | 5 | 6 | 7 | 8 | 9 | 10 |
|---|---|---|---|---|---|---|---|---|---|---|
| A | 1.0000 | 0.8019 | 0.1561 | 0.0422 | 0.0775 | 0.2834 | 0.2266 | 0.1196 | 0.0714 | 0.0954 |
| B | 0.0284 | 0.1192 | 0.0941 | 0.0167 | 0.0282 | 0.1724 | 0.0439 | 0.0924 | 0.0911 | 0.0756 |
| C | 0.0446 | 0.1089 | 0.0237 | 0.0277 | 0.0753 | 0.0147 | 0.0113 | 0.0737 | 0.1690 | 0.0196 |
| D | 0.0231 | 0.0017 | 0.0692 | 0.0662 | 0.1746 | 0.8093 | 0.0053 | 0.1389 | 0.1585 | 0.0394 |
| E | 0.0516 | 0.0005 | 0.0874 | 0.0757 | 0.1698 | 0.6956 | 0.0136 | 0.0565 | 0.0040 | 0.0588 |
| F | 0.0316 | 0.0998 | 0.0262 | 0.0268 | 0.1011 | 0.0121 | 0.0399 | 0.0378 | 0.1213 | 0.0352 |
| G | 0.0674 | 0.0066 | 0.1133 | 0.0680 | 0.1109 | 0.2289 | 0.0495 | 0.0775 | 0.1392 | 0.4077 |
| H | 0.1095 | 0.7016 | 0.0919 | 0.0058 | 0.0123 | 0.1448 | 0.0101 | 0.1300 | 0.2301 | 0.4096 |

TABLE VIII

| | 1 | 2 | 3 | 4 | 5 | 6 | 7 | 8 | 9 | 10 |
|---|---|---|---|---|---|---|---|---|---|---|
| A | 1 | 1 | 0 | 0 | 0 | 0 | 0 | 0 | 0 | 0 |
| B | 0 | 0 | 0 | 0 | 0 | 0 | 0 | 0 | 0 | 0 |
| C | 0 | 0 | 0 | 0 | 0 | 0 | 0 | 0 | 0 | 0 |
| D | 0 | 0 | 0 | 0 | 0 | 1 | 0 | 0 | 0 | 0 |
| E | 0 | 0 | 0 | 0 | 0 | 1 | 0 | 0 | 0 | 0 |
| F | 0 | 0 | 0 | 0 | 0 | 0 | 0 | 0 | 0 | 0 |
| G | 0 | 0 | 0 | 0 | 0 | 0 | 0 | 0 | 0 | 0 |
| H | 0 | 1 | 0 | 0 | 0 | 0 | 0 | 0 | 0 | 0 |

Table V was convolved with the kernel:
[1 1]

to create a 9 by 10 matrix, Table IX, where non-zero entries indicate bright-to-dark or dark-to-bright transitions in the x direction.

TABLE IX

| | 1 | 2 | 3 | 4 | 5 | 6 | 7 | 8 | 9 | 10 |
|---|---|---|---|---|---|---|---|---|---|---|
| A | 0 | 1 | 1 | 0 | 0 | 0 | 0 | 0 | 0 | 0 |
| B | 0 | 0 | 0 | 0 | 0 | 0 | 0 | 0 | 0 | 0 |
| C | 0 | 0 | 0 | 0 | 0 | 0 | 0 | 0 | 0 | 0 |
| D | 0 | 0 | 0 | 0 | 0 | 0 | 0 | 0 | 0 | 0 |
| E | 0 | 0 | 0 | 0 | 1 | 2 | 1 | 0 | 0 | 0 |
| F | 0 | 0 | 0 | 0 | 0 | 0 | 0 | 0 | 0 | 0 |
| G | 0 | 0 | 0 | 0 | 0 | 0 | 0 | 0 | 0 | 0 |
| H | 0 | 0 | 0 | 0 | 0 | 0 | 0 | 0 | 0 | 0 |
| I | 1 | 2 | 1 | 0 | 0 | 0 | 0 | 0 | 1 | 1 |

Table VIII was convolved with kernel:

$$[ \begin{matrix}1 \\ 1\end{matrix} ]$$

to create a 9 by 10 matrix, Table X, where non-zero entries indicate bright-to-dark-to-bright transitions in the y direction.

TABLE X

| | 1 | 2 | 3 | 4 | 5 | 6 | 7 | 8 | 9 | 10 |
|---|---|---|---|---|---|---|---|---|---|---|
| A | 1 | 1 | 0 | 0 | 0 | 0 | 0 | 0 | 0 | 0 |
| B | 1 | 1 | 0 | 0 | 0 | 0 | 0 | 0 | 0 | 0 |
| C | 0 | 0 | 0 | 0 | 0 | 0 | 0 | 0 | 0 | 0 |
| D | 0 | 0 | 0 | 0 | 0 | 1 | 0 | 0 | 0 | 0 |
| E | 0 | 0 | 0 | 0 | 0 | 2 | 0 | 0 | 0 | 0 |
| F | 0 | 0 | 0 | 0 | 0 | 1 | 0 | 0 | 0 | 0 |
| G | 0 | 0 | 0 | 0 | 0 | 0 | 0 | 0 | 0 | 0 |
| H | 0 | 1 | 0 | 0 | 0 | 0 | 0 | 0 | 0 | 0 |
| I | 0 | 1 | 0 | 0 | 0 | 0 | 0 | 0 | 0 | 0 |

The matrices represented by Tables IX and X were added, resulting in the matrix reported as Table XI.

TABLE XI

| | 1 | 2 | 3 | 4 | 5 | 6 | 7 | 8 | 9 | 10 |
|---|---|---|---|---|---|---|---|---|---|---|
| A | 1 | 2 | 1 | 0 | 0 | 0 | 0 | 0 | 0 | 0 |
| B | 1 | 1 | 0 | 0 | 0 | 0 | 0 | 0 | 0 | 0 |
| C | 0 | 0 | 0 | 0 | 0 | 0 | 0 | 0 | 0 | 0 |
| D | 0 | 0 | 0 | 0 | 0 | 1 | 0 | 0 | 0 | 0 |
| E | 0 | 0 | 0 | 0 | 1 | 4 | 1 | 0 | 0 | 0 |
| F | 0 | 0 | 0 | 0 | 0 | 1 | 0 | 0 | 0 | 0 |
| G | 0 | 0 | 0 | 0 | 0 | 0 | 0 | 0 | 0 | 0 |
| H | 0 | 1 | 0 | 0 | 0 | 0 | 0 | 0 | 0 | 0 |
| I | 1 | 3 | 1 | 0 | 0 | 0 | 0 | 0 | 1 | 1 |

Four rectangular regions were selected for deconvolution encompassing all of the non-zero values in Table XI (A1:B3, D5:F7, H1:I3, I9:I10). The selected regions included 23 out of 90 features, saving at least about 74% of the calculation effort that would have been involved in deconvolution of the entire image, and possibly much more, since many methods of deconvolution provide that the extent of the calculation effort rises exponentially with the size of the region analyzed.

Various modifications and alterations of this invention will become apparent to those skilled in the art without departing from the scope and principles of this invention, and it should be understood that this invention is not to be unduly limited to the illustrative embodiments set forth hereinabove.

1. A method to select areas of an image for deconvolution comprising the steps of:
a) providing an image comprising a plurality of features, wherein each feature is associated with at least one value (v);
b) identifying a test feature, said test feature being a high-value feature adjacent to a known low-value zone of the image, wherein said test feature has a tail ratio (rₜ), said tail ratio being the ratio of the value of the test feature (vₜ) to the value of said adjacent low-value zone of the image (vₒ);
c) calculating a threshold value t, said threshold value (T(rₜ)) being a function of tail ratio (rₜ) of said test feature; and
d) identifying selected areas of said image, said selected areas including less than the entire image, said selected areas being those areas where the ratio of values (v) between adjacent features is greater than said threshold value (T(rₜ)).

2. The method according to claim 1, wherein step b) additionally comprises subtracting a background constant from both the value of the test feature (vₜ) and the value of the adjacent low-value zone of the image (vₒ) before calculating the tail ratio (rₜ).

3. The method according to claim 2, wherein said background constant is taken to be the value of a (v_{b}) of a low-value zone of the image which is sufficiently distant from any feature as to avoid any tail effect.

4. The method according to claim 2, wherein said background constant is taken to be the value of a (v_{b}) of a low-value zone of the image which is at least twice as distant from any feature as the average distance between features.

5. The method according to claim 1, additionally comprising the step:
e) forming a pseudo-image by autogrid analysis.

6. The method according to claim 1, wherein said threshold value (T(rₜ)) is a multiple of tail ratio (rₜ) of said test feature.

7. The method according to claim 1, wherein said features are arranged in a grid.

8. The method according to claim 1, additionally comprising the step:
f) deconvolving the selected areas of said image.

9. A system for selecting areas of an image for deconvolution, the system comprising:
b) an image device for providing a digitized image;
c) a data storage device; and
d) a central processing unit for receiving the digitized image from the image device and which can write to and read from the data storage device, the central processing unit being programmed to:
i) receive a digitized image from the image device;
ii) identify a plurality of features and associate each feature with at least one value (v);
iii) identify a test feature, said test feature being a high-value feature adjacent to a known low-value zone of the image, wherein said test feature has a tail ratio (rₜ), said tail ratio being the ratio of the value of the test feature (vₜ) to the value of said adjacent low-value zone of the image (vₒ);
iv) calculate a threshold value t, said threshold value (T(rₜ)) being a function of tail ratio (rₜ) of said test feature; and
v) identify selected areas of said image, said selected areas including less than the entire image, said selected areas being those areas where the ratio of values (v) between adjacent features is greater than said threshold value (T(rₜ)).

10. The system of claim 9, wherein the central processing unit is further programmed to subtract a background constant from both the value of the test feature (vₜ) and the value of the adjacent low-value zone of the image (vₒ) before calculating the tail ratio (rₜ).

11. The system of claim 10, wherein said background constant is taken to be the value of a (v_{b}) of a low-value zone of the image which is sufficiently distant from any feature as to avoid any tail effect.

12. The system of claim 10, wherein said background constant is taken to be the value of a (v_{b}) of a low-value zone of the image which is at least twice as distant from any feature as the average distance between features.

13. The system of claim 9, wherein the central processing unit is further programmed to form a pseudo-image by autogrid analysis.

14. The system of claim 9, wherein said threshold value (T(rₜ)) is a multiple of tail ratio (rₜ) of said test feature.

15. The system of claim 9, wherein said features are arranged in a grid.

16. The system of claim 9, wherein the central processing unit is further programmed deconvolve the selected areas of said image.
